(19) United States
(12) Patent Application Publication
(10) Pub. No.: US 2012/0101895 A1
(43) Pub. Date: Apr. 26, 2012

(54) ADVERTISING SYSTEM AND METHOD

(75) Inventor: David Banham, Crows Nest (AU)

(73) Assignee: Online Interactive Marketing Pty Limited, Botany (AU)

(21) Appl. No.: 13/173,166

(22) Filed: Jun. 30, 2011

(30) Foreign Application Priority Data
Oct. 21, 2010 (AU) 2010904702

(51) Int. Cl. G06Q 30/00

(52) U.S. Cl. 705/14.49; 705/14.4; 705/14.73

(57) ABSTRACT

A method for operating a user terminal to deliver advertising content to a user of the user terminal prior to the user commencing use of a software program on the user terminal is provided. The user terminal includes a processor and associated memory, a communications interface, and at least one output device. The method includes sending, via the communications interface, a service request to a software server, the service request including a request to use said software program; receiving, via the communications interface, a service response and an advertising reference from the software server; and delivering advertising content to the user through the at least one output device, the advertising content being derived from the advertising reference.

### CLAIM OF PRIORITY

The present patent application claims the priority benefit of the filing date of Australian Patent Application No. 2010904702, filed Oct. 21, 2010, the entire content of which is incorporated herein by reference in its entirety.

### FIELD OF THE INVENTION

The present invention relates to a system and method for delivering advertising content. For illustrative purposes, the invention will be described in relation to an embodiment that allows delivery of advertising content to a user prior to commencing the execution of a software program.

### BACKGROUND OF THE INVENTION

The development of computer software is a high cost and high risk business. However computer software can be rapidly duplicated at very low cost. This stark contrast, coupled with the increasing pervasiveness of the internet, has driven many software developers to write software for delivery/use according to service like model. Under a service model, a user wishing to use the software interacts with one or more servers which provide various services relevant to the software. Such servers are operated by services providers, who may be the software developer/owner themselves, or a third party chosen by the software developer/owner.

For example, a server may provide the user with a temporary copy of the software for the duration the software is used, or may simply provide the user with an interface to the software (with processing being done at the server or other remote location). Alternatively, the software may reside on the user's computer and connection to the server may be necessary in order to enable use of the software. In addition to simply enabling use of the software, the server may offer additional or enhanced software functionality or features to the user. For example, the server may act as an aggregation point to facilitate the interaction of multiple users, for example, to aggregate many players into a single virtual world in which they can interact.

When software is offered under a service model, it can be difficult to obtain payment from users for a multitude of reasons. The users may, for example, reside in a foreign country, making it difficult to transfer funds using many standard financial means. Users may be, for example because of their age, unable to use alternative means of payment such as credit cards. Another consideration is that the software developer/owner and/or service providers may wish to offer services at no or limited cost to the end user, and/or that end users themselves may expect services to be offered on such a basis. In this case an alternative revenue model to a simple sales model is required.

Reference to any prior art in the specification is not, and should not be taken as, an acknowledgment or any form of suggestion that this prior art forms part of the common general knowledge.

It would be desirable to provide a system and/or method for generating a revenue stream derived from the use of software through a service provider.

### SUMMARY OF THE INVENTION

In one aspect the present invention provides a method for operating a user terminal to deliver advertising content to a user of the user terminal prior to the user commencing use of a software program on the user terminal. The user terminal includes a processor (such as a microprocessor) and associated memory, a communications interface, and at least one output device. The method includes: sending, via the communications interface, a service request to a software server, the service request including a request to use said software program; receiving, via the communications interface, a service response and an advertising reference from the software server; delivering advertising content to the user through the at least one output device, the advertising content being derived from the advertising reference.

Use of the software may commence automatically after delivery of the advertising content, or on receiving a user input to continue.

The service request may include a request for one or more additional services to be used with said software program.

The service request may include a request for data and/or software content necessary for the use of the software program at the user terminal.

The service request may include a request to use the software in a collaborative mode with other users.

The software program may be a video game.

The service request may be a request to play the video game in a multiplayer mode with other users of the same video game.

The advertising content may include content selected from one or more of the following: a document, an image, a sound, a video, an interactive presentation.

The advertising reference may be a reference to an advertising server on which some or all of the advertising content is stored.

The reference may be a hypertext link to a file stored on the advertising server.

The method may further include: using said reference to send, via the communications interface, an advertising request to the advertising server, and receiving, via the communications interface, advertising content from the advertising server.

The advertising content may further include instructions which cause the user terminal to communicate analytical information to an advertising tracking server.

The advertising content may include an advertising client link and, if said advertising client link is activated by the user the method may further include: sending, via the communications interface, a request to the advertising server for an advertising client URL associated with the advertising client link; receiving, via the communications interface, the advertising client URL from the advertising server; sending, via the communications interface, a client advertising request to a client advertising server using said client URL; receiving, via the communications interface, advertising client information from the advertiser client server, and delivering said advertiser client information to the user.

In another aspect the present invention provides a method for operating a software server to facilitate the delivery of advertising content to a user of a user terminal prior to the user commencing use of a software program on the user terminal, the software server including a processor and associated memory, and a communications interface, the method including: receiving, via the communications interface, a service request from the user terminal, the service request being a request to use said software program; querying a database to obtain an advertising reference relevant to said service request, said advertising content being accessible by said user terminal from said advertising reference; sending, via the communications interface, a service response to the user terminal; and sending, via the communications interface, the advertising reference to the user terminal.

The service request may include a request for one or more additional services to be used with said software program, and wherein the service response includes data and/or information necessary to allow use of the software program with the one or more additional services.

The service request may include a request from the user terminal to use the software in a collaborative mode with other users.

The software program may be a video game.

The service request may be a request to play the video game in a multiplayer mode with other users of the same video game.

The advertising reference may be a reference to an advertising server on which advertising content is stored.

The reference may be a hypertext link to a file stored on the advertising server.

In a further aspect the present invention provides a method for operating an advertising server to deliver advertising content to a user of a user terminal prior to the user commencing use of a software program on the user terminal, the advertising server including a processor and associated memory and a communications interface, the method including: receiving, via the communications interface, an advertising request from the user terminal, sending, via the communications interface, advertising content to the user terminal, said advertising content including instructions which cause the user terminal to communicate analytical information to an advertising tracking server; tracking the sending of the advertising content to the user terminal; and receiving, via the communications interface, and storing analytics information regarding the user terminal from the user terminal.

The advertising content may further include an advertising client link and, if said advertising client link is activated by the user of the user terminal, the method further includes: receiving, via the communications interface, data indicative of the activation of the advertising client link; tracking said user activation of the advertising client link; and sending, via the communications interface, a link to advertising client information stored on an advertiser client server to the user terminal.

The advertising content may further include content selected from one or more of the following: a document, an image, a sound, a video, an interactive presentation.

In a further aspect the present invention provides computer readable instructions executable by a processor to implement the method described in any one or more of the above statements.

In a further aspect the present invention provides a computer readable storage medium readable by a processor, the storage medium storing instructions as described above.

In a further aspect the present invention provides a computer system including a processor and associated memory, a communications interface, and at least one output device, the memory storing instructions that, when executed, cause the system to implement the method described above.

According to a further aspect, the invention broadly resides in a data signal carrying instructions and/or data executable to implement the method as described above.

### BRIEF DESCRIPTION OF THE DRAWINGS

For illustrative purposes only, an embodiment of the present invention will now be described with reference to the accompanying drawings, in which:

FIG. 1 is a diagram of a system suitable for use with the present invention;

FIG. 2 is a diagram of a computing device suitable for use with the present invention;

FIGS. 3A and 3B are flow charts depicting operations that take place at an advertising server in accordance with an embodiment of the present invention;

FIG. 4 is a flow chart depicting operations that take place at a user terminal in accordance with an embodiment of the present invention;

FIG. 5 is a flow chart depicting operations that take place at a software server in accordance with an embodiment of the present invention;

FIGS. 6A to 6C show illustrative depictions of client terminal screen layouts in accordance with an embodiment of the invention; and

FIG. 7 shows a swim-lane type diagram depicting high level communications occurring in embodiments of the invention.

### DETAILED DESCRIPTION OF THE EMBODIMENTS

Broadly speaking, the present invention relates to a method and system for delivering advertising content to a user of a software program. The software program allows or requires the user to connect to a software server prior to the software being used, the software server providing services in relation to the software program.

The method and system will be described in specific relation to computer/video game software, and connection to a software server for the provision of a multiplayer service (i.e. a service which allows the user to play the computer game with other players over a communications network).

It will, however, be appreciated that the various features of invention can be used with alternative software programs and/or alternative service offerings.

### System Overview

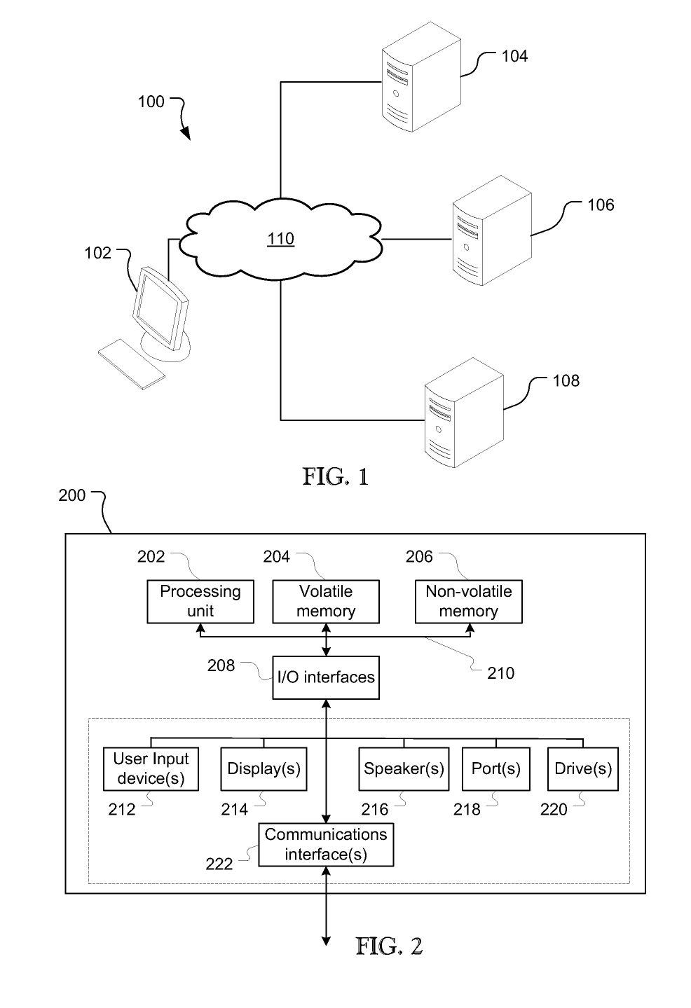

FIG. 1 of the accompanying diagrams shows an overview of a networked system 100 which includes a user terminal 102, a software server 104, an advertising server 106, and a client server 108, all of which are interconnected via a communications network 110, such as the Internet.

It will be appreciated that while the various servers have been illustrated as separate physical computer systems, the software server 104, advertising server 106, and/or client server 108 could be virtual servers sharing the resources of a single physical server. For example, the software server 104 and advertising server 106 could be virtual servers running on a single physical server.

As described in more detail below, a user accesses and uses a software program through a user terminal 102. In using the software program the user terminal 102 connects to the software server 104 via the network 110 to obtain one or more services relevant to the software program. As described below, the service may simply be the use of the software, or may be a service which increases or supplements the functionality of the software. For example, the software may be computer game and a service offered by the software server 104 may allow play of the video game with other users in a multiplayer mode.

In addition providing the relevant services to the user terminal 102, the software server 104 provides an advertising reference to the user terminal 102. In the embodiment described below the advertising reference is a reference (such as a universal resource locator (URL)) to advertising content located on the advertising server 106. Prior to or during the use of the software the advertising content is retrieved from the advertising server 106 by the user terminal 102 and delivered to the user.

Providing a link/reference to the advertising content allows for the content to be stored on a server other than the software server. This can be advantageous as the advertising content may contain large amounts of data and rich media designed to be provided in a best effort manner. By providing this content from a separate advertising server 106 the processes of the software server 104 are not unduly interfered with. In the multiplayer game example, this may serve, for example, to reduce data latency and provide users with more responsive gameplay.

Additionally, the provision of a reference/link allows a party other than the party owning/operating the software server to maintain accurate records as to the number of times that a particular advertisement has been displayed (so called ‘impressions’) and/or interacted with (clicks). This provides both a degree of assurance as to the veracity of the tracking data, but also allows for strategic decisions to be made by the party controlling the advertising server 106 as to the particular content to be displayed.

Further, the provision of a reference allows for a mechanism of geographic or load-based splitting of advertising traffic. This approach can help to ensure that the advertising server 106 chosen to deliver advertising content to a user terminal 102 is both nearby and at or below a maximum level of utilization.

The advertising content delivered to the user by the advertising server 106 is commissioned by an advertising client. In one embodiment the advertising client runs its own client server 108, though it is not necessary that the advertising client runs such a server.

### Computer Architecture

FIG. 2 is a block diagram of a computing device 200. The user terminal 102, software server 104, advertising server 106, and client server 108 will each typically have similar general components as computing device 200. As such, each of the user terminal 102, software server 104, advertising server 106, and client server 108 will be described below using the components and reference numerals of the computing device 200 of FIG. 2 for illustration. Despite using the same reference numerals to describe the components of the client and various servers it will, of course, be appreciated that the user terminal 102, software server 104, advertising server 106, and client server 108 will generally be different computing devices.

The computing device 200 includes at least one processing unit 202. The processing unit may include a single processing device (e.g. a microprocessor or other computational device), or may include a plurality of processing devices. Additionally, the processing unit may include local processing devices only, or may include distributed processing devices accessible and useable (either in a shared or dedicated manner) by the device 200.

Through a communications bus 210 the processing unit 202 is in data communication with volatile memory 204 (e.g. random access memory including one or more DRAM modules) and non-volatile memory 206 (e.g. one or more hard disk drives, solid state disk drives, and/or ROM devices such as one or more EPROMs). Instructions and data to control operation of the processing unit 202 are stored on the volatile and/or non-volatile memory 204 and 206.

The computing device 200 also includes one or more input/output interfaces 208 which interface with a plurality of input/output devices. As will be appreciated, a wide variety of input/output devices may be used, including intelligent input/output devices having their own memory and/or processing units. In this instance the device 200 includes (by way of non-limiting example): user input devices 212 (e.g. a keyboard, mouse, touch-screen etc); a display 214 (e.g. a monitor/video display unit); speakers 216; one or more ports 218 for interfacing with additional devices (e.g. USB ports, Firewire ports, eSata ports, serial ports, parallel ports, SD card port, Compact Flash port, etc); one or more drives 220 (e.g. compact disc drives, DVD drives, Blue-Ray drives); and a communications interface 222 (e.g. a Network Interface Card allowing for wired or wireless connection to a network, such as network 110).

Communication with the communications network 110 (and other devices connected thereto) will typically be by the protocols set out in the layers of the OSI model of computer networking. For example, applications/software programs being executed by the processor 202 may communicate using one or more transport protocols, e.g. the Transmission Control Protocol (TCP, defined in RFC 793) or the User Datagram Protocol (UDP, defined in RFC 768).

In one embodiment, various aspects/features of the invention are embodied in computer software programs/applications. The programs include computer-readable instructions which can be executed by processing units (such as unit 202) of the various terminals/servers to implement the relevant aspects of the invention. The instructions may be conveyed to the relevant terminal/server by means of a data signal in a transmission channel. Examples of such transmission channels include wired or wireless network connections enabled by the communications interface 222 and various communications protocols.

### Advertising Server Process

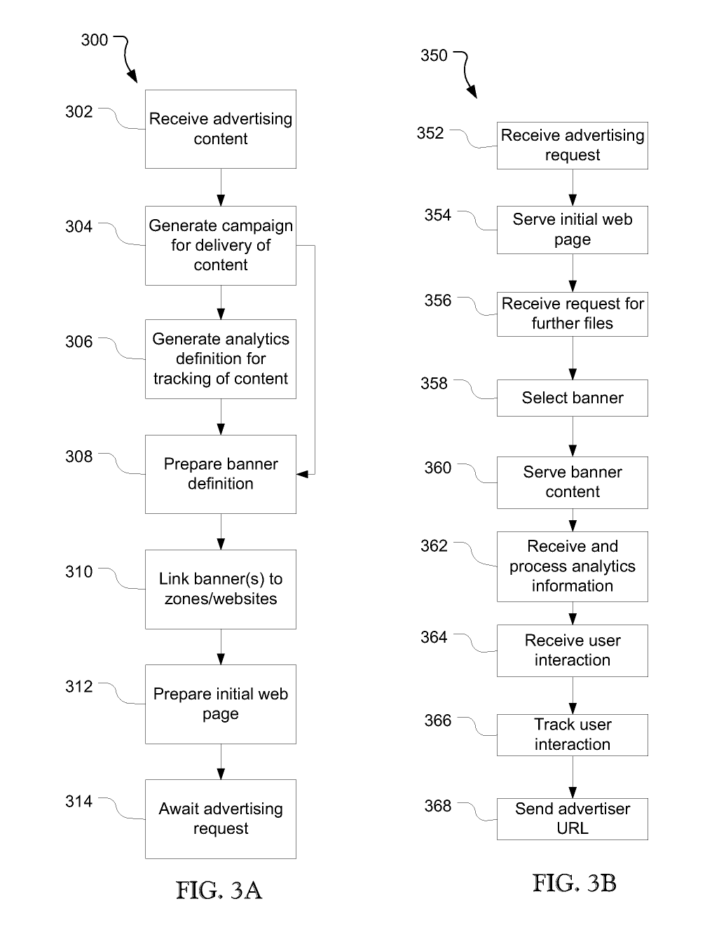

FIGS. 3A and 3B show flow charts 300 and 350 setting out operations that take place at the advertising server 106 in accordance with an embodiment of the invention. It will be appreciated that while the various steps of the flow charts are depicted in a linear fashion, it may be possible for the order of some steps to be changed, for certain steps to be performed concurrently, and/or for certain steps to be omitted entirely.

Flow chart 3A relates to the operations for preparing the advertising server 106 to deliver and track the delivery of advertising content. Flow chart 3B relates to the operations whereby the content is delivered and tracked by the advertising server 106. The operations are facilitated by the instructions of one or more software programs which are stored on a memory device accessible by the advertising server 106 (such as memory 206) and executed by a processing unit of the advertising server 106 (such as processing unit 202).

The advertising server of the present embodiment runs a number of software programs/applications. These include a web-server application for receiving and responding to request for content, an advertising delivery application (for delivering advertising), an analytics application (for tracking and analysing the delivery of advertising and associated information), and database software (e.g. mySQL) for storing data used by the web-server, advertising delivery application, and analytics application.

Referring initially to FIG. 3A, the preparation of the advertising server 106 and content is will be described. In step 302 advertising content provided by the advertising client uploaded to the advertising server 106 where it is stored in a database on a memory (e.g. a non-volatile memory such as memory 206).

The advertising content may be sent to the advertising server 106 from a client server 108 over the communications network 110 (and received via an advertising server communications interface such as interface 222), or may be delivered to the advertising server 106 by alternative means (e.g. on a portable storage device such as a disc or flash memory). Alternatively, the advertising client may commission either the owner/operator of the advertising server 106 or an entirely independent third party to generate the advertising content and deliver the advertising content to the advertising server 106.

A variety of types of advertising content are possible. For example, the advertising content may include graphics (e.g. a .jpg file, a .gif file, or file in an alternative image format), audio content (e.g. a .mp3 file, a .wav file, or a file in an alternative audio format), video content (e.g. a .avi file, a .mpg file, or file in an alternative video file format) or a combination thereof. Alternatively, or additionally, richer advertising content may be provided. For example, the advertising content may be a HTML microsite, an Adobe® Flash® application file, or other interactive or non-interactive content.

In step 304 records for the particular client and an advertising campaign associated with the content are created to allow the advertising content to be delivered by an advertising delivery application. In this embodiment the advertising delivery application used is OpenX which is an advertising delivery, rotation and tracking server designed to serve banner advertising to websites. Alternative advertising delivery systems may, of course, be used, for example the Orbit, AdServer, DFP, or DART Enterprise systems.

In step 306, an analytics definition for the advertising campaign for use by an analytics application is created. In the present embodiment the web analytics program Piwik is used. Use of an analytics program allows rich advertising data to be tracked, such as the geographical location of the user terminal 102 and the ISP servicing the user terminal 102 (based in the IP address of the user terminal 102), and system configuration information of the user terminal 102 (e.g. screen resolution, operating system, and browser plugins installed). Piwik also stores a cookie on the user terminal 102 where possible and uses that cookie to track repeat visits versus unique visits. Alternative analytics programs may, of course be used (e.g. Google Analytics by way of one example).

It is noted that in some embodiments use of an additional analytics program (and the various steps associated therewith) may be omitted. For example, the OpenX advertising delivery system does in fact allow for the basic tracking of impressions (i.e. the number of times advertising content is served to a user terminal) and clicks (i.e. the number of times an impression is clicked on by a user). While this could be relied upon use of an analytics program allows for richer data to be tracked, and, consequently, may allow for more effective advertising campaigns designed and implemented.

At step 308 an advertising banner definition is prepared and added to the advertising campaign. The advertising banner definition may itself include some or all of the advertising content, and/or may include links/references to further files in which advertising content is stored.

By way of one specific (though non-limiting) example, a banner definition may be as follows:

Banner definition

```
<style type=“text/css”>
  body { background: #2c2c2c; margin: 2px; width: 100%;}
  #banner {position:absolute; top:0; left:0; width:100%;}
</style>
<centre>
<ahref=“{clickurl}http://advertising_client.com ”>
<imgid=“banner” src=
  “http:// advertising_server.com/ads/content/advertising_client/
  advertising_client.jpg”
  alt=“advertising_client” /></a></center><br /> <br/>
<!-- Piwik -->
<script type=“text/javascript”>
var pkBaseURL = ((“https:”==document.location.protocol) ?
“https://advertising_server.com/piwik/” :
“http://advertising_server.com/piwik/”);
document.write(unescape(“%3Cscript src=”‘ + pkBaseURL + “piwik.js’
type=‘text/javascript’%3E%3C/script%3E”));
</script><script type=“text/javascript”>
try {
  var piwikTracker = Piwik.getTracker(pkBaseURL + “piwik.php”,
6);
  piwikTracker.trackPageView( );
  piwikTracker.enableLinkTracking( );
  } catch( err ) { }
</script><noscript><p>
<img src=
  “http://advertising_server.com/piwik/piwik.php?idsite=6”
  style=“border:0” alt=“” /></p></noscript>
<!-- End Piwik Tag -->
```

The banner definition includes HTML, CSS and Javascript code which together define how the advertisement will be presented, the location that the advertising content in question has been stored on the advertising server 106, the website a user should be directed to if they click on the banner, and the identifier(s) to use when reporting back to the analytics software (in this instance Piwik).

In step 310 the banner definition is associated to relevant Websites and Zones in which it will be displayed. When OpenX is used as a banner rotation system, the “Website” parameter refers to the Website to which the banner is to be delivered, and the “Zone” parameter refers to an area of the Website that the banner is to be displayed. Where a website has multiple zones, OpenX can be configured to show one or more different campaigns. In the present embodiment the Website parameter is typically used to define a partner network (i.e. a software server offering services, such as the Australian Bigpond Games server/website), and the Zone parameter is typically used to define a specific software title (e.g. the game “Left 4 Dead 2”, the game “Team Fortress 2”, or the game “Alien Swarm”).

In order to deliver the banner definition (and, ultimately, the advertising content) to the client terminal an initial web page file to be served to the user is also created (step 312). For example:

Initial web page

<html>
<body>
<style type=“text/css”>
body { background: #2c2c2c;
padding:0px;margin:0px;}
</style>
<iframe id=‘adfaa7c8’ name=‘adfaa7c8’
src=‘http://advertising_server.com/openx/www/delivery/afr.php?zoneid=
2’ frameborder=‘0’ scrolling=‘auto’ width=‘100%’ height=‘100%’><img
src=‘http://advertising_server.com/openx/www/delivery/avw.php?zoneid
=2&amp;n=a33b2ba4’ border=‘0’ alt=“ /></iframe>
<!-- Piwik -->
<script type=“text/javascript”>
var pkBaseURL = ((“https:” ==document.location.protocol) ?
“https://advertising_server.com/piwik/” :
“http://advertising_server.com/piwik/”);
document.write(unescape(“%3Cscript src=’” + pkBaseURL + “piwik.js‘
type=’text/javascript’%3E%3C/script%3E”));
</script><script type=“text/javascript”>
try {
var piwikTracker = Piwik.getTracker(pkBaseURL + “piwik.php”, 3);
piwikTracker.trackPageView( );
piwikTracker.enableLinkTracking( );
} catch( err ) { }
</script><noscript><p><img
src=“http://advertising_server.com/piwik/piwik.php?idsite=3”
style=“border:0” alt=”” /></p></noscript>
<!-- End Piwik Tag -->
</body>
</html>

As will be noted, the “idsite” parameter in the initial web page (set at 3) is different to the “idsite” parameter in the banner definition (set at 6). The idsite in the banner definition is used to track the individual banner. In the initialweb page code, however, the idsite is being used to track the zone in which the advertisement is displayed. This allows the tracking of different advertisements (and/or different advertisers) within the same Website and Zone. For example, if both advertiser 1 and advertiser 2 are advertising within the same Zone (e.g. Team Fortress 2), the banner of the first advertiser is assigned idsite=1, the banner of the second advertiser is assigned idsite=2, and the zone itself is assigned idsite=3. Each time the first advertiser's banner is displayed in the space, zoneid's 1 and 3 are both incremented. Conversely, each time the second advertiser's banner is displayed, zoneids 2 and 3 are both incremented. In this way a count is kept (allowing useful data mining/analysis) based both on the banner and the total zone. For example, analysis of the data can show that zoneid 3 (Team fortress 2) displayed 10 impressions, 6 of them being the first advertiser's banner and 4 being the second advertiser's banner. It is also possible to generate a report, for example as to location data based on the total zone, then broken down into individual advertisers and banners.

In this instance the banner is displayed in an iframe. As will be appreciated, it would be possible for the initial web page to be automatically generated by the advertising server 106 as and when requested by a user, rather than being pre-generated.

In the initial web page file HTML code is used to request the advertising banner from the OpenX server (as described below). CSS (cascading style sheet) code is used to assist in displaying the content correctly regardless of the display resolution at the user terminal and regardless of the specific software program being used (which may run different embedded browsers). For example, the CSS code for use with the “Team Fortress 2” software program (which runs embedded webkit) is different to the CSS code for use with the “Counter-Strike” software program (which runs embedded Internet Explorer 5). Javascript code is used to enable the tracking of the delivery of the advertising content via the analytics software (e.g. Piwik).

At this point the advertising server is ready to deliver and track the delivery of the advertising content, and simply awaits the receipt of requests for such delivery (step 314).

Turning to FIG. 3B, the delivery and tracking of advertising content will be described. At step 352 the advertising server 106 (and in particular the web-server application running on the advertising server 106) receives an advertising request from the user terminal 102 (see step 410 of the user terminal process).

In response to the advertising request the advertising sever 106 (via the web-server application) serves the initial web page to the user terminal 102 (step 354).

The user terminal 102 processes the initial web page (step 412 of the user terminal process discussed below) and in doing requests further pages (i.e. files) from the advertising server 106 (step 356). In this particular example, and referring to the code of the initial HTML page above, a PHP page is requested by the user terminal 102:
http://advertising_server.com/openx/www/delivery/avw.php?zoneid=2& amp;n=a33b2ba4

The request of this PHP page results in the activation of the advertising delivery application—the OpenX software in this instance—at the advertising sever 106. Upon activation, OpenX queries its database to determine which banners are linked to the zone specified in the request (indicated by the ‘zoneid’ parameter, in this instance “2”) and if multiple banners are linked, which banner should be delivered to the client terminal 102 (step 358). The decision as to which of the banners linked to the campaign is to be delivered may be made in a variety of ways. For example the banner decision may be made according to how many impressions a banner has been booked to achieve on that day. If all booked impressions have been accounted for, the decision may be made based on inputted weightings of the remnant campaigns. By way of alternative, linked banners may be selected by a simple rotation or even random process.

Once the banner to be delivered has been selected, the advertising server 106 (or, more particularly, the advertising delivery application operating thereon) queries its database again to obtain the content of the banner to be delivered. At step 360 the content is then served to the user terminal 102. A suitable HTML file for delivery of the content is as follows. As with the initial web page this could be generated in response to the user request, or could be pre-generated and stored in memory for delivery on demand:

Banner delivery file

```
<!DOCTYPE html PUBLIC ‘-//W3C//DTD XHTML 1.0
Transitional//EN’ ‘http://www.w3.org/TR/xhtml1/DTD/xhtml1-
transitional.dtd’>
<html xmlns=‘http://www.w3.org/1999/xhtml’ xml:lang=‘en’ lang=‘en’>
<head>
<title>Advertisement</title>
<style type=‘text/css’>
body {margin:0; height:100%; background-color:transparent;
width:100%; text-align:center;}
</style>
</head>
<body>
<style type=“text/css”>
    body { background: #2c2c2c; margin: 2px; width:
100%;}
#banner {position:absolute; top:0; left:0; width:100%;}
  </style>
  <center>
<a
href=“http://advertising_server.com/openx/www/delivery/ck.php?oapara
ms=2_bannerid=21_zoneid=2_cb=d4a6c70885_oadest=http://advert
ising_client.com”><img id=“banner”
src=“http://advertising_server.com/ads/creative/zambrero/advertising_cli
ent.jpg” alt=“Advertising_client” /></a></center><br /> <br/>
<!-- Piwik -->
<script type=“text/javascript”>
var pkBaseURL = ((“https:” ==document.location.protocol) ?
“https://advertising_server.com/piwik/” :
“http://advertising_server.com/piwik/”);
document.write(unescape(“%3Cscript src=”‘ + pkBaseURL + “piwik.js’
type=‘text/javascript’%3E%3C/script%3E”));
</script><script type=“text/javascript”>
try {
var piwikTracker = Piwik.getTracker(pkBaseURL + “piwik.php”, 6);
piwikTracker.trackPageView( );
piwikTracker.enableLinkTracking( );
} catch( err ) { }
</script><noscript><p><img
src=“http://advertising_server.com/piwik/piwik.php?idsite=6”
style=“border:0” alt=“” /></p></noscript>
<!-- End Piwik Tag --><div id=‘beacon_d4a6c70885’ style=‘position:
absolute; left: 0px; top: 0px; visibility: hidden;’><img
src=‘advertising_server.com/openx/www/delivery/lg.php?bannerid=21&a
mp;campaignid=15&amp;zoneid=2&amp;loc=1&amp;cb=d4a6c70885’
width=‘0’ height=‘0’ alt=” style=‘width: 0px; height: 0px;’ /></div>
</body>
</html>
```

Also included in the banner delivery file is the Javascript tracking code of the banner definition file.

The banner delivery file may include of any one or more of HTML, Javascript, CSS, or other code. Typically, the file will also contain references to other assets/files (e.g. graphic assets, flash files, video files etc) which may be hosted on the advertising server 106, the client server 108, or elsewhere. If additional files located on the advertising server 106 are requested these are also delivered to the client terminal 102 by the advertising server 106.

As the banner delivery file is parsed by the user terminal 102 additional code may be requested from the advertising server 106 to assist in the advertising tracking process. For example, the additional code may be used to gather analytics information about the client terminal 102 (as described above) and send this information back to the advertising server 106 for processing by the analytics program (e.g. Piwik). The additional analytics information from the client terminal 102 is received and processed at the advertising server 106 at step 362. Piwik processes the analytics information by writing the information to its database along with the “idsite” identifier which, in this case, identities the campaign and/or individual banner that the analytics data should be associated with.

As the banner delivery page is rendered at the user terminal 102, the user may click on the advertisement/banner. In this case the user terminal 102 requests the file defined for this action. In the current example this file is:
http://advertising_server.com/openx/www/delivery/ck.php?oaparams=2_bannerid=21_zoneid=2_cb=d4a6c70885_oadest=http://advertising_client.com

If the user clicks on the advertisement, the user interaction is received at the advertising server 106 at step 364. The user interaction activates the OpenX software on the advertising server 106 which records the click of the advertisement by the user in its database against the bannerid that was clicked (21) and the zoneid (2) that the banner was displayed in (step 366). At step 368 the advertising server 106 sends back the defined URL (in this instance http://advertising_client.com) to the user terminal 102.

### User Terminal Process

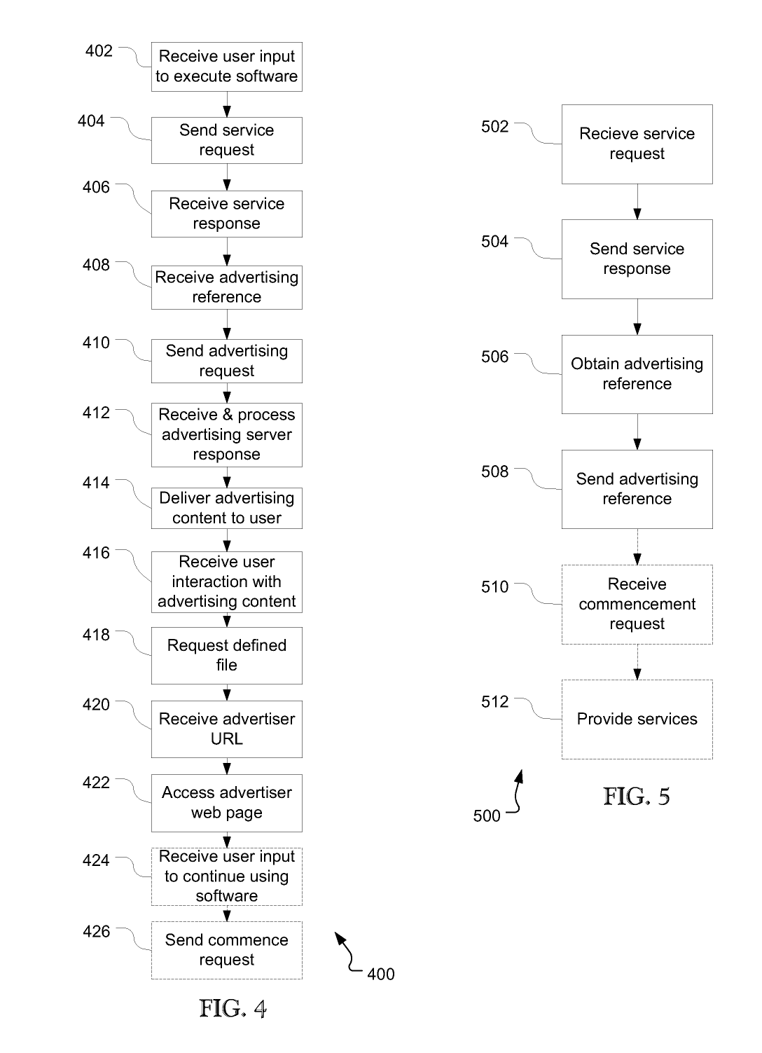

FIG. 4 shows a chart 400 setting out operations that take place at the user terminal 102 in accordance with an embodiment of the invention. Once again it is noted that despite the linear depiction of the steps, it may be possible for the order of some steps to be changed, for certain steps to be performed concurrently, and/or for certain steps to be omitted entirely.

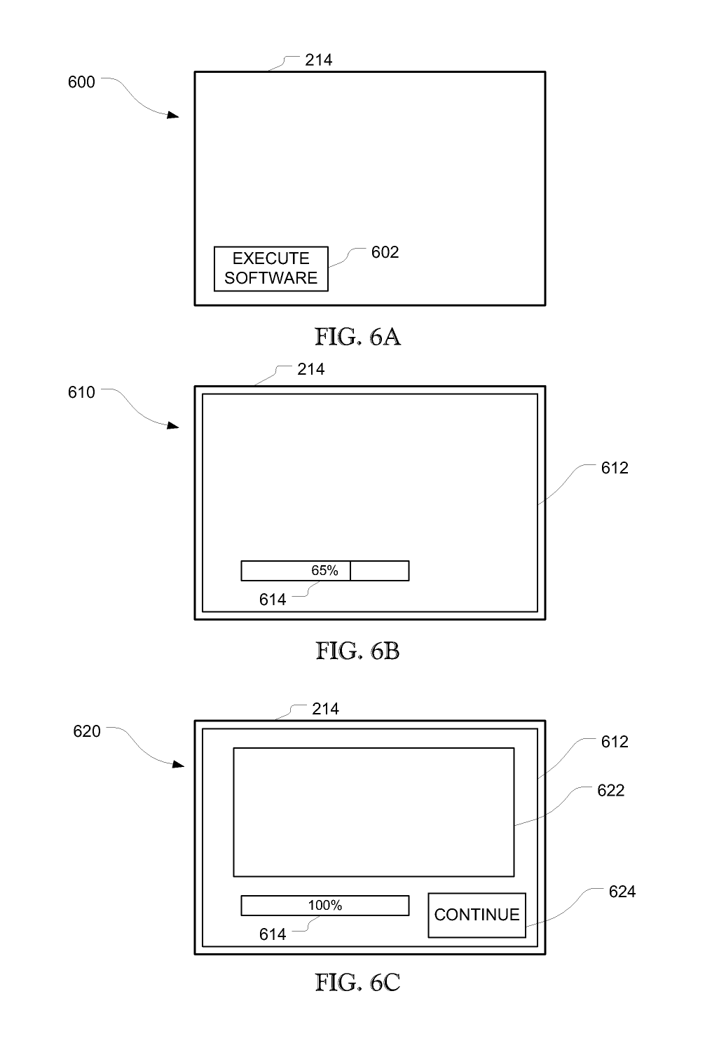

The user terminal operations will also be described with reference to FIGS. 6A to 6C, which provide illustrative depictions of screen layouts (displayed on a display such as display 214) by which a user interacts with the user terminal 102. Alternative screen layouts are, of course, possible.

The user interface and user terminal operations are facilitated by the instructions of one or more software programs which are stored on a memory device accessible by the user terminal 102 (such as memory 206) and executed by a processing unit of the user terminal 102 (such as processing unit 202). The software programs running at the user terminal 102 will include the primary software program the user intends to use (e.g. the actual video game software program). In addition, and in some instances, additional/ancillary software programs will also be run at the client terminal 102 which may provide for additional functionality and/or the delivery of services requested by the user. Turning again to the specific video game embodiment, additional software may include the Steam platform developed by the Valve Corporation, which provides distribution, rights management, communications, and multiplayer services.

In step 402 the user inputs a command/request to execute the software program. In one embodiment the software program is a video game, and the request is a request to commence play of a video game in a multiplayer game play mode as facilitated by software server 104. As depicted in screen layout 600 of FIG. 6A, this request may be made, for example, by double-clicking or otherwise activating an icon 602.

In step 404, the user terminal 102 sends, via the communications interface 222, a service request to the software server 104. The software program may be programmed such that the user cannot commence using the software unless the service request is sent and an appropriate response received from the software server 104. In this instance the service request may be for nothing more than a request for “standard” use of the software (i.e. with no additional functionality or services). Alternatively, the software may be programmed to enable execution without sending a service request and/or receiving a response thereto, in which case the service request may be a request for the provision of particular services to augment the functionality of the software. In the present multiplayer video game example, the service request is a request to either join or host a multiplayer game mode of the video game software.

On receiving the software execution request from the user terminal 102 the software server 104 responds by sending a service response and an advertising reference to the user terminal 102. The service response and advertising reference are received by the user terminal 102 in steps 406 and 408. The actual order in which these are received may, of course differ. For example, the software server 104 may initially respond with data/content in respect of the service request, and on receiving confirmation from the user terminal 102 that the information/content has been received may then send the advertising reference. Alternatively, the service response and advertising reference may be sent together.

The service response generally includes data and/or content that enables the use of the software as desired by the user. In the multiplayer video game example, the response includes data that allows the user terminal 102 to establish a connection to the software server 104 in order to join or host a multiplayer instance of the video game. Screen layout 610 depicts a user interface 612 provided by the software program (e.g. the video game) or an ancillary software program (e.g. Steam). The user interface 612 shows a status bar 614 providing a visual representation of the progress of the service request.

The advertising reference sent by the software server 104 includes data and/or content that facilitates the delivery of advertising content to the user terminal 102. This advertising content (or part thereof) is delivered to the client prior to the user actually using the software—e.g. prior to the user commencing game play.

In the present embodiment the advertising reference includes a link to the location of initial web-page stored on the advertising server 106. For example:
http://advertising_server.com/ads/bgn/video_game/initial_page.html

The user terminal 102 uses the advertising reference to formulate and send an advertising request to the advertising server 106 (step 410). The advertising server 106 responds by serving a web page (the initial page) to the user terminal 102. This is received and processed by the user terminal at step 412, and delivered to the user at step 414 (typically by displaying visual content on a display such as display 214 and/or audio content via speakers such as speakers 216). FIG. 6C provides a depiction of a screen layout 620 in which the advertising content 622 is displayed to the user.

As described above in relation to the advertising server process, several requests to the advertising server 106 and responses therefrom may be sent/received by the user terminal 102 in the advertising delivery process. Referring to the specific example, during the processing of the initial page by the user terminal 102 the user terminal 102 requests the PHP page:
http://advertising_server.com/openx/www/delivery/avw.php?zoneid=2& amp;n=a33b2ba4

This results in the advertising sever 106 delivering the banner delivery file (which includes the actual advertising banner) to the user terminal 102. The user terminal 102 parses the file which may result in further data/files being requested. Additionally (and, again, as described above), the processing of the file may result in the user terminal 102 requesting further code from the advertising server 106 which, when processed, results in the user terminal 102 sending relevant analytics information to the advertising server 106.

The user may also elect to interact with the advertising content, for example by clicking on the advertising banner (i.e. in area 622 of FIG. 6C) served by the advertising server 106 (at step 416). If the user clicks on the advertisement, the user terminal 102 requests the defined file from the advertising server 106 (step 418). In the present example, this file is:
http://advertising_server.com/openx/www/delivery/ck.php?oaparams=2_bannerid=21_zoneid=2_cb=d4a6c70885_oadest=http://advertising_client.com

At step 420 the URL sent from the advertising server 106 in response to the user clicking on the advertisement is received, and at step 422 the user terminal 102 requests the file defined in that URL (http://advertising_client.com). Typically this will be a link to a web-page hosted by the advertising client itself on the client server 108. The web page may be opened within the existing software program (i.e. in interface 612) or a new interface (such as a web-browser program) may be launched. At this point communication is directly between the user terminal 102 and the client server 108, and the user may elect to undertake further operations with the client server 108.

At step 424, and once all data/content relevant to the service request has been received, the user inputs a command to continue and commence use of the software. This may, for example, be by activation of a “continue” button/link 624 displayed by either the main software program (e.g. the video game) or an ancillary software program (such as Steam).

Depending on the software and/or any requested services, commencement of the use of the software program at the user terminal 102 may be an entirely local process or may require further communication with the software server 104 (or another server). If further communication with the server is required (e.g. in order to obtain additional data necessary for use of the software with the requested service), the user terminal 102 sends a commencement request to the software server 104 (step 426). Alternatively, if commencement of the use of the software does not require further communication with the software server (i.e. all data necessary to use the software with the requested service is already held at the user terminal 102), further communication with the software server at step 426 is, of course, not necessary.

As will be appreciated, various advertising requirements can be implemented either by the instructions of the software program itself, ancillary software programs, and/or by the software server providing the software service(s). For example, the advertising content may be delivered with an option for the user to skip the advertising (e.g. by providing a link/button which when operated by the user skips any remaining advertising content and launches the software). Alternatively, the software program may be written to require that the entirety of the advertising content be viewed before the user can commence use the software (i.e. play the game). Continuing use of the software program after deliver of the advertising content may require the user to activate a continue button/link (or similar), or the software program may launch automatically after the delivery of the advertising content.

Advertising content may be delivered to the client terminal 102 (as described above) each time a service is requested/delivered, or at various points through the delivery of the service. Further additionally, or alternatively, the software may provide the user with an option to view previously delivered advertising content (or unseen advertising content) at any time—e.g. via a user input command. In the multiplayer video game example, advertising content may be delivered for each new game/map that is started by the user. The specific advertising content delivered by the advertising server 106 could, of course change on each delivery.

### Software Server Process

FIG. 5 shows a chart 500 setting out operations that take place at the software server 104 in accordance with an embodiment of the invention. As with the above, it may be possible for the order of some steps to be changed, for certain steps to be performed concurrently, and/or for certain steps to be omitted entirely. The operations are facilitated by one or more software programs stored on a memory device accessible by the software server 104 (such as memory 206), the software including instructions which are executed by a processing unit of the software server 104 (such as processing unit 202). As will be appreciated, the software server operations of chart 400 complement the user terminal operations described above with reference to chart 400.

In step 402 the software server 104 receives a service request from the user terminal 102.

On receipt of the service request the software server 104 prepares and sends a service response (step 504) and an advertising reference (step 508) to the user terminal 102. Once again it is noted that while the preparation and sending of the service response and advertising content have been depicted in chart 500 as linear steps, these steps may be undertaken in a different order or, in fact, concurrently.

The precise content of the service response will depend on the particular software program, the requirements of that program, the details of the user terminal 102 (or user thereof), and the details of the service request. For example, if the software program requires the software server to send an enabling authorisation before the software can be used on the user terminal, the software sever 104 will process the credentials of the user/user terminal 102 (included in the service request) and, if the credentials are acceptable, send a service response to enable the use of the software program on the user terminal 102. If other services are requested, the software server 104 can respond as appropriate to the particular request. Such responses may involve the server 104 querying local and/or remote databases and/or obtaining data/content from local and/or remote sources to send to the user terminal 102.

In the present example where the service request includes a request for game play in a multiplayer mode, the software server would respond with data/instructions to provide for a connection between the user terminal 102 and a multiplayer game server running on the software server 104 to be established. Through this connection the user can host or join a multiplayer instance of the video game and play the game with other users.

In addition to sending the service response, the software server 104 prepares and sends the advertising reference to the user terminal 102. This involves the software server 104 querying a database stored on a memory of the software server 104 (such as memory 206) to obtain the advertising reference relevant to the service request received. The advertising reference may, for example, include an advertising link to the advertising server 106 on which the advertising content is stored. By way of example, the advertising reference may be held in a configuration file titled “motd.txt” (motd standing for message of the day). Continuing with the specific example above, the link returned from this query may be:
http://advertising_server.com/ads/bgn/video_game/initial_page.html

The link is then sent to the user terminal 102 at step 508.

As described above, once the service response and advertising reference is sent the user terminal 102 uses the advertising reference to deliver advertising content to the user. The user can then continue with the operation of the software program.

If continued operation of the software program requires further data from the software server 104, the software server 104 receives the commencement request from the user at step 510, and at step 512 provides the necessary data/instructions/content to the user terminal 102 in response.

### High Level Communication Flow

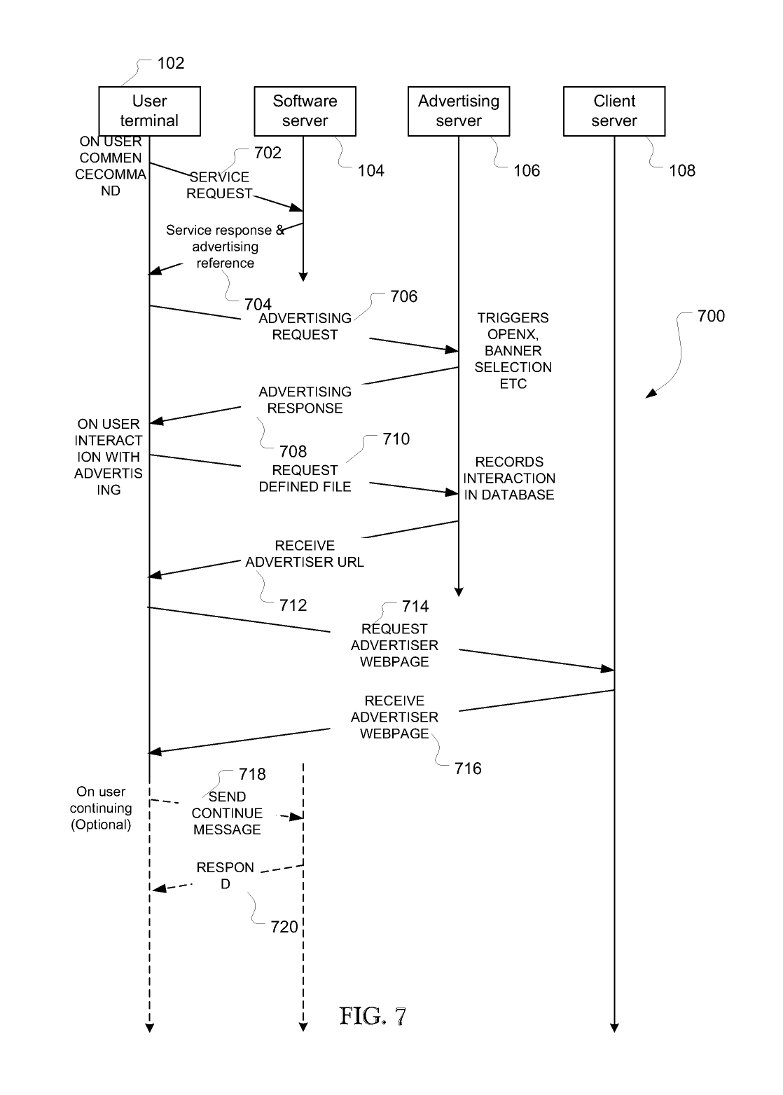

FIG. 7 provides a simplified swim-lane type diagram 700 of high level communications between the user terminal 102, the software server 104, the advertising server 106, and the client server 108 in delivering advertising content to the user terminal 102. The communications shown are in accordance with the specific embodiment of the invention described above and are shown/described below to assist in the understanding of the invention only.

When the user inputs the command to execute the software (step 402 above) a service request 702 is sent to the software server 104. The software server 104 receives and processes the service request and responds to the user terminal 102 with the service response and the advertising reference 704 (steps 502, 504, 506, and 508 above).

The user terminal 102 receives and processes the advertising reference, and sends an advertising request 706 to the advertising server 106 (steps 408 and 410). The advertising server 106 receives the request and responds by serving the initial web page at 708 (steps 352 and 354 above). As is described above, further requests and responses (not explicitly shown in diagram 700) pass between the user terminal 102 and advertising server 106 during the processing/delivery of the advertising content (e.g. steps 356 and 360 above).

If the user interacts with the content delivered by the advertising server 106 (e.g. by clicking on the content), the file defined in the HTML is requested from the advertising server 106 (at 710) (step 418). The advertising server receives and processes the request, tracks the user interaction, and responds to the user terminal 102 (at 712) with the advertiser URL (steps 364, 366, and 368 above).

The user terminal 102 receives the advertiser URL and sends a request 714 to the client server 108 (steps 420 and 422 above). The client server 108 receives the request and responds 716 with the relevant webpage.

When the user elects to continue, and if required, the user terminal 102 sends a message 718 to the software server 104 (step 426). The software server 104 responds with the relevant data/content/service at 720 to allow the user to commence use of the software program as desired. As described above, messages 718 and 720 are not necessary in all embodiments of the invention. For example, in some instances commencing use of the software program (by the uses electing to continue or similar) will be an entirely local process—i.e. all data and information required to use the software program is already stored/loaded on the user terminal 102.

It will be understood that the invention disclosed and defined in this specification extends to all alternative combinations of two or more of the individual features mentioned or evident from the text or drawings. All of these different combinations constitute various alternative aspects of the invention.

What is claimed is:

1. A method for operating a user terminal to deliver advertising content to a user of the user terminal prior to the user commencing use of a software program on the user terminal, the user terminal including a processor and associated memory, a communications interface, and at least one output device, the method including:
sending, via the communications interface, a service request to a software server, the service request including a request to use said software program;
receiving, via the communications interface, a service response and an advertising reference from the software server; and
delivering advertising content to the user through the at least one output device, the advertising content being derived from the advertising reference.

2. The method according to claim 1, wherein the service request includes a request for one or more additional services to be used with said software program.

3. The method according to claim 1, wherein the service request includes a request for data and/or software content necessary for the use of the software program at the user terminal.

4. The method according to claim 1, wherein the service request includes a request to use the software in a collaborative mode with other users.

5. The method according to claim 1, wherein the software program is a video game.

6. The method according to claim 5, wherein the service request is a request to play the video game in a multiplayer mode with other users of the same video game.

7. The method according to claim 1, wherein the advertising content includes content selected from one or more of the following: a document, an image, a sound, a video, an interactive presentation.

8. The method according to claim 1, wherein the advertising reference is a reference to an advertising server on which some or all of the advertising content is stored.

9. The method according to claim 8, wherein the advertising reference is hypertext link to a file stored on the advertising server.

10. The method according to claim 8, further including:
using said advertising reference to send, via the communications interface, an advertising request to the advertising server, and
receiving, via the communications interface, advertising content from the advertising server.

11. The method according to claim 1, wherein the advertising content further includes instructions which cause the user terminal to communicate analytical information to an advertising tracking server.

12. The method according to claim 1, wherein the advertising content includes an advertising client link and, if said advertising client link is activated by the user the method further includes:
sending, via the communications interface, a request to the advertising server for an advertising client URL associated with the advertising client link;
receiving, via the communications interface, the advertising client URL from the advertising server;
sending, via the communications interface, a client advertising request to a client advertising server using said client URL;
receiving, via the communications interface, advertising client information from the advertiser client server, and
delivering said advertiser client information to the user.

13. A method for operating a software server to facilitate the delivery of advertising content to a user of a user terminal prior to the user commencing use of a software program on the user terminal, the software server including a processor and associated memory, and a communications interface, the method including:
receiving, via the communications interface, a service request from the user terminal, the service request being a request to use said software program;
querying a database to obtain an advertising reference relevant to said service request, said advertising content being accessible by said user terminal from said advertising reference;
sending, via the communications interface, a service response to the user terminal; and
sending, via the communications interface, the advertising reference to the user terminal.

14. The method according to claim 13, wherein the service request includes a request for one or more additional services to be used with said software program, and wherein the service response includes data and/or information necessary to allow use of the software program with the one or more additional services.

15. The method according to claim 13, wherein the service request includes a request from the user terminal to use the software in a collaborative mode with other users.

16. The method according to claim 13, wherein the software program is a video game.

17. The method according to claim 16, wherein the service request is a request to play the video game in a multiplayer mode with other users of the same video game.

18. The method according to claim 13, wherein the advertising reference is a reference to an advertising server on which advertising content is stored.

19. The method according to claim 18, wherein the advertising reference is hypertext link to a file stored on the advertising server.

20. Computer readable instructions executable by a processor to implement a method to operate a user terminal to deliver advertising content to a user of the user terminal prior to the user commencing use of a software program on the user terminal, the user terminal including the processor and associated memory, a communications interface, and at least one output device, the method including:
sending, via the communications interface, a service request to a software server, the service request including a request to use said software program;
receiving, via the communications interface, a service response and an advertising reference from the software server; and
delivering advertising content to the user through the at least one output device, the advertising content being derived from the advertising reference.

21. A computer readable storage medium readable by a processor, the storage medium storing instructions executable by a processor to implement a method to operate a user terminal to deliver advertising content to a user of the user terminal prior to the user commencing use of a software program on the user terminal, the user terminal including the processor and associated memory, a communications interface, and at least one output device, the method including:
sending, via the communications interface, a service request to a software server, the service request including a request to use said software program;
receiving, via the communications interface, a service response and an advertising reference from the software server; and
delivering advertising content to the user through the at least one output device, the advertising content being derived from the advertising reference.

22. A computer system including a processor and associated memory, a communications interface, and at least one output device, the memory storing instructions that, when executed, cause the computer system to implement a method to deliver advertising content to a user of the computer system prior to the user commencing use of a software program on the computer system, the method including:
sending, via the communications interface, a service request to a software server, the service request including a request to use said software program;
receiving, via the communications interface, a service response and an advertising reference from the software server; and
delivering advertising content to the user through the at least one output device, the advertising content being derived from the advertising reference.

23. Computer readable instructions executable by a processor to implement a method to operate a software server to facilitate the delivery of advertising content to a user of a user terminal prior to the user commencing use of a software program on the user terminal, the software server including the processor and associated memory, and a communications interface, the method including:
receiving, via the communications interface, a service request from the user terminal, the service request being a request to use said software program;
querying a database to obtain an advertising reference relevant to said service request, said advertising content being accessible by said user terminal from said advertising reference;
sending, via the communications interface, a service response to the user terminal; and
sending, via the communications interface, the advertising reference to the user terminal.

24. A computer readable storage medium readable by a processor, the storage medium storing instructions executable by a processor to implement a method to operate a software server to facilitate the delivery of advertising content to a user of a user terminal prior to the user commencing use of a software program on the user terminal, the software server including the processor and associated memory, and a communications interface, the method including:
receiving, via the communications interface, a service request from the user terminal, the service request being a request to use said software program;
querying a database to obtain an advertising reference relevant to said service request, said advertising content being accessible by said user terminal from said advertising reference;
sending, via the communications interface, a service response to the user terminal; and
sending, via the communications interface, the advertising reference to the user terminal.

25. A computer system including a processor and associated memory, a communications interface, and at least one output device, the memory storing instructions that, when executed, cause the computer system to implement a method to facilitate the delivery of advertising content to a user of a user terminal prior to the user commencing use of a software program on the user terminal, the method including:
receiving, via the communications interface, a service request from the user terminal, the service request being a request to use said software program;
querying a database to obtain an advertising reference relevant to said service request, said advertising content being accessible by said user terminal from said advertising reference;
sending, via the communications interface, a service response to the user terminal; and
sending, via the communications interface, the advertising reference to the user terminal.
